(19) United States
(12) Patent Application Publication
(10) Pub. No.: US 2002/0113794 A1
(43) Pub. Date: Aug. 22, 2002

(54) Method and device for editing the moving path of a multimedia object

(76) Inventor: Po-Cheng Wu, Changhua (TW)

Correspondence Address: BIRCH STEWART KOLASCH & BIRCH, PO BOX 747, FALLS CHURCH, VA, 22040-0747, US

(21) Appl. No.: 10/076,512

(22) Filed: Feb. 19, 2002

(30) Foreign Application Priority Data
Feb. 19, 2001 (TW) 90103696

(51) Int. Cl. G06T 13/00; G06T 15/70; G09G 5/00

(52) U.S. Cl. 345/474; 345/649; 345/660; 345/672; 345/810

(57) ABSTRACT

A moving-path editor for editing a moving path of a multimedia object and the editing method using the same are provided. The moving-path editor includes a browser interface, an input module and a combination module. The browser interface provides a transition parameter group, a rotation parameter group and a scale parameter group for storing a plurality of preloaded settings, respectively. The input module is used to receive the input of the user and select at least one transition setting, one rotation setting and one scale setting selected, respectively, from the preloaded settings. The combination module combines all selected settings and creates the moving path of the designated multimedia object.

### BACKGROUND OF THE INVENTION

1. Field of the Invention

The invention relates to a method and device of processing multimedia objects. More specifically, the invention relates to a method and device for editing the moving path of multimedia objects in an animation editing apparatus by utilizing grouping parameters of the moving path. These parameters includes transition settings, rotation settings and scaling settings, which may be utilized so that the moving path of a multimedia object can be quickly obtained.

2. Description of the Prior Art

With the help of increased memory capacities, high-speed processors, increased data compression ratios, and improved transmission quality on the net, multimedia computers providing image—and video—intensive entertainment have become enormously popular. Further, the creative use of computers in the creation of a variety of audio-visual products is rapidly increasing.

In these multimedia applications, in order to increase dynamic appeal, a moving-path editing function, which is a technique used to endow multimedia objects with movement capabilities, is desirable. In a traditional multimedia application, a moving-path editor is usually designed for professional users so that the operating interface of the editor does not address the considerations of ordinary users. For example, the user must first set numerous precise parameters, such as transition setting, rotation setting, and scaling settings in order to determine the moving path of a multimedia object. The determination of these settings is also based on the experiences of the user. Accordingly, the user interface of the moving-path editor is unfriendly to fresh users.

FIG. 1 (Prior Art) illustrates an example of the moving paths of a multimedia object 100, where symbols X and indicate starting and goal positions of the multimedia object 100 along several moving paths. When a user wishes to move the object 100 from X to Y, several possible moving paths exist. For example, these possible moving paths from position X to position Y include a linear path (denoted by P path), a transitive path (denoted by Z path) and a zigzag path (denoted by K path). FIG. 2A (Prior Art) and 2B (Prior Art) illustrate an example of the user interface for editing the moving path of the multimedia object 100 in the conventional moving-path editor. In FIG. 2A, the user first selects a type of the moving path, such as a 3D moving path. Thus, as shown in FIG. 2B, a template corresponding to the selected type of the moving path is selected and applied to the designated multimedia object 100. Next, the user must adjust the parameters pertaining to the designated multimedia object, such as its size, position, moving direction, moving speed and rotating angle, thereby completing the setting process for the moving path. When a complicated path, such as a zigzag path (for example, the K path in FIG. 1), is selected, the user has to divide the complicated path into several segments in order to repeat the above-mentioned steps, thereby creating the model of the complicated path. The professional operating interface offers flexibility to allow a professional to create all the possible paths, but is not suitable for newer users.

### SUMMARY OF THE INVENTION

Accordingly, an object of the invention is to provide moving-path editor and the editing method using the same, which can quickly create the moving path of a multimedia object.

The present invention discloses a novel moving-path editor and the editing method using the same, which can quickly create the moving path of a multimedia object. The editor includes a browser interface, an input module and a combination module. The browser interface includes a transition parameter group, a rotation parameter group, and a scale parameter group. In addition, there are a plurality of preloaded transition settings pertaining to the transition parameter group, a plurality of preloaded rotation settings pertaining to the rotation parameter group and a plurality of preloaded scale settings pertaining to the scale parameter group, respectively. The input module is used to pick up a transition setting, a rotation setting and a scale setting from the preloaded transition settings, the preloaded rotation settings and the preloaded scale settings, respectively, according to the input of the user. The combination module utilizes all the selected settings to create the moving path of the multimedia object.

The editing method in the present invention includes the following steps. First, the user selects at least one transition setting, one rotation setting and one scale setting from the preloaded transition settings, the preloaded rotation settings and the preloaded scale settings, respectively, through the browser interface. Second, these selected settings are combined into a moving-path setting, which can describe the features of the desired moving path. Finally, the moving-path setting is applied to the selected multimedia object and to create its moving path.

The invention is used to facility the operation of the user while creating the moving path of a multimedia object, and further to reduce the workload of the user.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 (Prior Art) illustrates an example of the moving paths of a multimedia object;

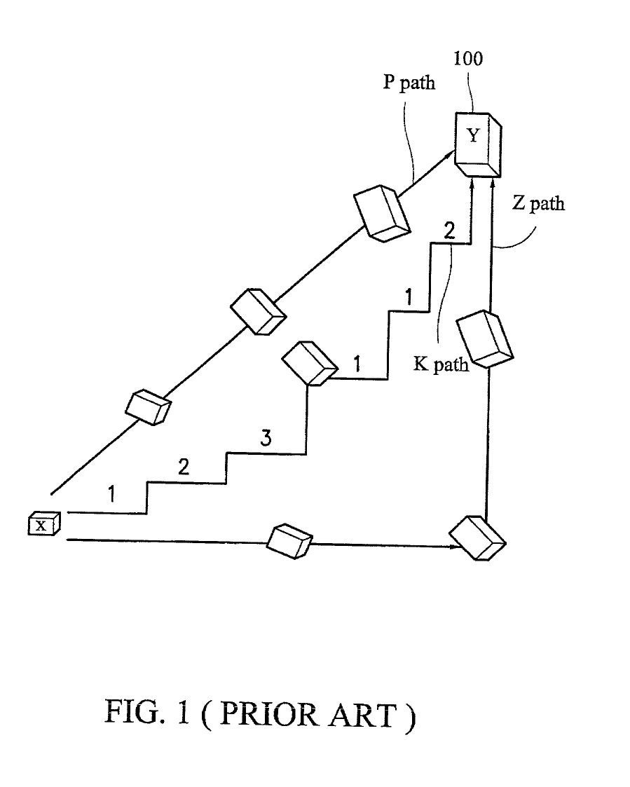

FIGS. 2A and 2B (Prior Art) illustrate an example of the user interface for editing the moving path of a multimedia object in the conventional moving-path editor;

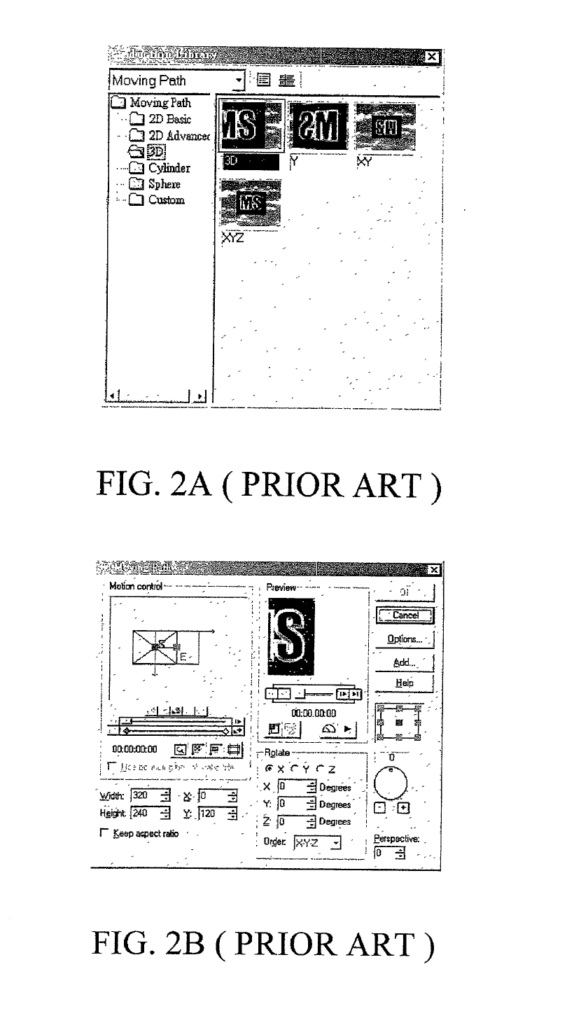

FIG. 3 is a block diagram illustrating the moving-path editor for editing a moving path according to the embodiment of the present invention;

FIGS. 4A and 4B illustrates examples of a browser interface in the moving-path editor according to the embodiment of the present invention; and

FIG. 5 is a flowchart of the methed of editing the moving path of the multimedia object according to the embodiment of the present invention.

### DETAILED DESCRIPTION OF THE INVENTION

The invention provides a novel moving-path editor and the editing method thereof, allowing both newer and professional users to easily create the desired moving path.

In order to achieve the above objectives, it is necessary to first analyze the editing action of a moving path. A user usually utilizes the settings of three parameters, including transition, rotation and scale, for describing the features of the moving path. That is, most of moving paths at least have one or more of the three parameters or any combination thereof. The transition parameters are used to determine the moving direction when the multimedia object moves along the moving path. The rotation parameters are used to determine the rotation model and the rotation speed when the multimedia object moves along the moving path. The scale parameters are used to determine the scale of the object when the object moves along the path. Generally speaking, the user can set the transition parameters to be several fixed models, such as a line, a turn and a zigzag path. In addition, the user can set the rotation parameters to be clockwise and counterclockwise. For the scale parameters, the user can determine if the object is contractive or expansive. Therefore, a moving path of a multimedia object can be easily created if a simple interface including these parameters is provided in such a way that a user can create the desired moving path by selecting the appropriate parameters.

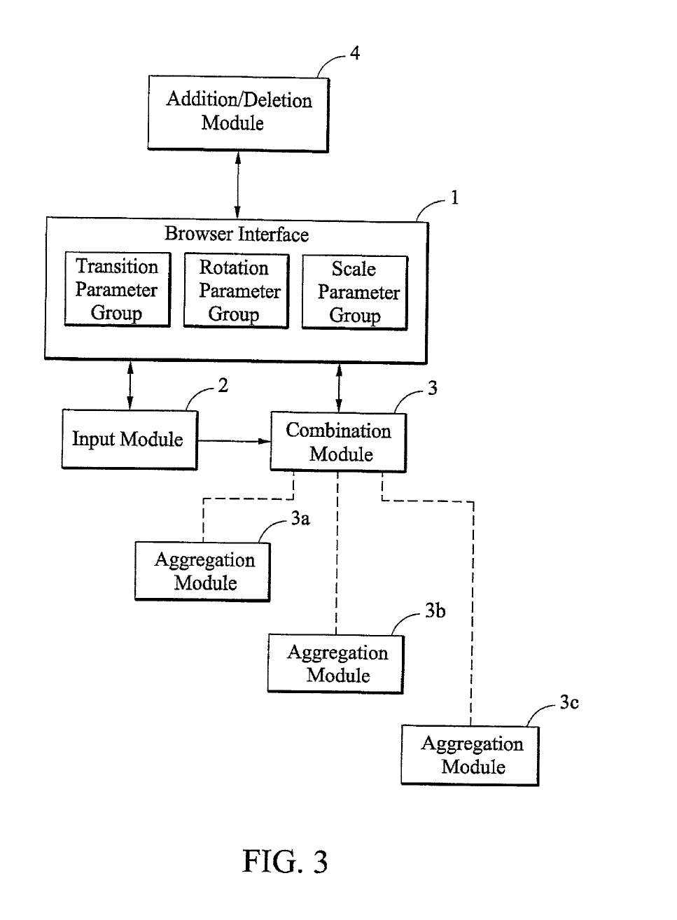

FIG. 3 is a block diagram illustrating the moving-path editor for editing a moving path of a selected object in an animation editing apparatus in the preferred embodiment of the present invention. In FIG. 3, the moving-path editor includes a browser interface 1, an input module 2, and a combination module 3. The browser interface 1 includes a transition parameter group, a rotation parameter group and a scale parameter group, each of which respectively stores a plurality of preloaded settings. The input module 2 is used to receive the instruction of the user and to select at least one transition setting, one rotation setting and one scale setting, respectively, from the preloaded transition settings, the preloaded rotation settings and the preloaded scale settings. The combination module 3 combines all selected settings pertaining to the three parameters into a moving-path setting for creating the moving path of the designated multimedia object.

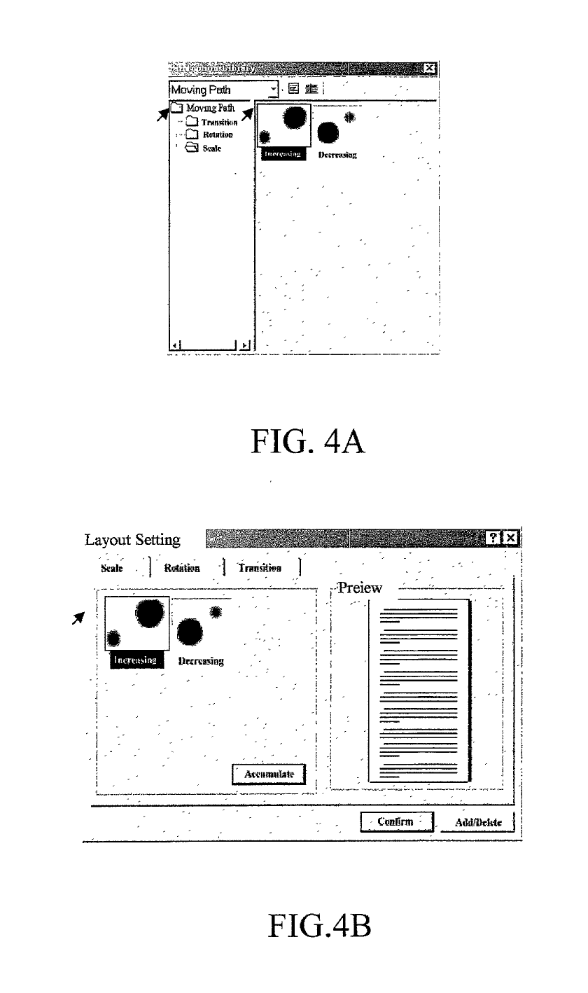

FIGS. 4A and 4B show two examples of the browser interface 1 in the preferred embodiment of the present invention. In FIGS. 4A and 4B, the browser interface 1 can arrange the transition parameter group, the rotation parameter group and the scale parameter group using a tree graph or a list graph, thereby facilitating the input process of the users for the full range of parameters. In addition, every setting of a parameter is denoted by an different easily-recognized icon and/or a different general term. In addition, the browser interface 1 of the present invention also includes a preview area for allowing the users to preview the effects of the desired settings prior to make a choice. The difference between the present invention and the conventional moving-path editor is that, in the present invention, the users need not adjust or enter complicated settings, such as size, position, direction, speed, and rotation angle. The settings are preloaded into the parameter groups according to the habits of most users.

The input module 2 can be a keyboard, mouse, or other input modules.

The combination module 3 is achieved by means of drag and drop, instruction, and other commonly accepted methodology. For example, the combination module is achieved by means of the drag and drop technique in the embodiment of the tree-type browser interface. A user can select the desired settings to be applied from the preloaded settings in the tree browser interface according to a mouse click, an interpretable command or directly dragging the icon representing the desired setting to the multimedia object, thereby completing the combination function. In this example, the settings can be selected individually and completely applied to the selected multimedia object. In the example of the list-type browser interface, the combination module 3 is achieved by a confirmation command through a dialog box. That is, the user can select the settings in different lists and apply them to the selected multimedia object through a confirmation command. In this example, the settings can be pre-selected and applied to the selected multimedia object in one step. The manner of achieving the combination module in the mentioned embodiment is not used to limit the scope of the invention. In addition, the combination module 3 may comprise one or a plurality of aggregation modules (3a, 3b and 3c) for preveiously combining several transition, rotation and scale settings, respectively. In the example of the tree-type browser interface, the user can sequentially drag two or more transition (or rotation and scale) settings to generate an aggreviated transition setting.

Also, the moving-path editor of the present invention also provides an addition/deletion module 4 for managing the preloaded settings. In the present inveniton, the user can open a dialog box with a field for setting the parameters through the addition/deletion module 4. Thus, the user further adjusts the pre-stored settings of every parameter group through the dialog window.

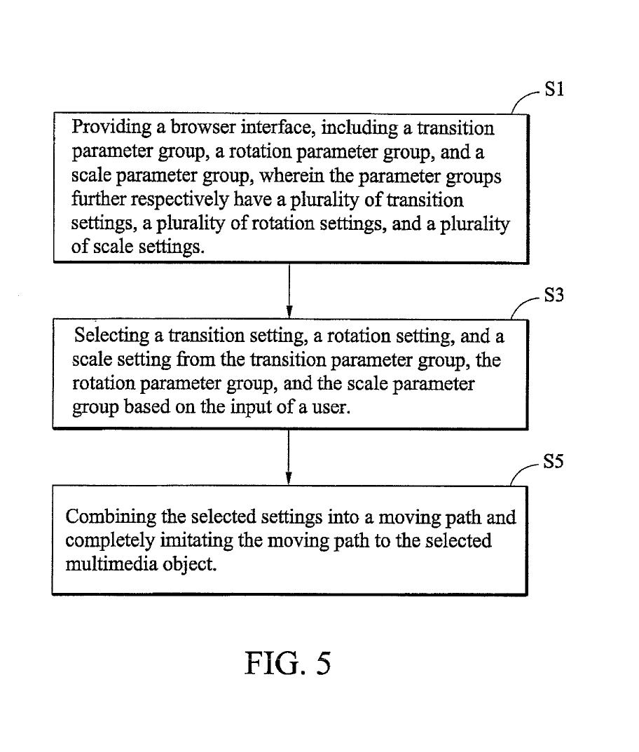

FIG. 5 shows a flowchart of the method of editing the moving path of the multimedia object in the present invention. The moving-path editing method includes the following steps. First, a browser interface 1, which including a transition parameter group Tm, a rotation parameter group Rn, and a scale parameter group Sh, is provided, wherein symbols m, n and h represent the predetermined number of transition settings, rotation settings and scale settings (step S1). Next, a transition setting, a rotation setting and a scale setting are respectively selected from the transition parameter group Tm, the rotation parameter group Rn and the scale parameter group Sh, based on the instruction of the user (step S3). Finally, the selected settings are combined by the combination module into a moving-path setting for creating the moving path of the selected multimedia object (step S5).

According to the method of editing the moving path in the FIG. 5, any configuration can be built up if a plurality of preloaded settings are respectively stored for the three basic moving-path parameters, i.e., the transition, the rotation and the scale. For example, if ten preloaded settings exist for each parameter, the number of the possible configuration is up to 1000.

The browser interface can be a tree or a list, as shown in FIGS. 4A and 4B. Moreover, a preview area in the browser interface is provided to display the result of the combined settings.

In addition, the combining step can comprise an step for aggregating more than one transition, rotation and scale settings into an aggregation transition setting, an aggregation rotation setting and an aggregation scale setting, respectively. In addition, using the addition/deletion module as mentioned above, an adding and deleting step is included in order to add or delete the respective settings of the parameter group.

In summary, the inventive method for creating a moving path of a multimedia object offers many features to speed up and simplify the user operation. The flexibility of combining the settings is a feature of the invention.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A moving-path editor used in an animation editing apparatus for editing a moving path of a selected multimedia object, comprising:
a browser interface including a transition parameter group, a rotation parameter group and a scale parameter group, which have a plurality of preloaded transition settings, a plurality of preloaded rotation settings and a plurality of preloaded scale settings, respectively;
an input module for respectively selecting a transition setting, a rotation setting and a scale setting from the preloaded transition settings of the transition parameter group, the preloaded rotation settings of the rotation parameter group and the preloaded scale settings of the scale parameter group; and
a combination module for combining the selected transition setting, the selected rotation setting, and the selected scale setting to create the moving path of the selected multimedia object.

2. The moving-path editor of claim 1, wherein the browser interface further includes a tree graph for illustrating the preloaded transition settings, the preloaded rotation settings and the preloaded scale settings.

3. The moving-path editor of claim 1, wherein the browser interface further includes a list graph for illustrating the preloaded transition settings, the preloaded rotation settings and the preloaded scale settings.

4. The moving-path editor of claim 3, wherein the browser interface further includes a preview area for previewing the corresponding effect of selecting the preloaded transition settings, the preloaded rotation settings and the preloaded scale settings.

5. The moving-path editor of claim 1, wherein the combination module has an aggregation module for selectively combining at least two of the preloaded transition settings to generate the selected transition setting.

6. The moving-path editor of claim 1, wherein the combination module has an aggregation module for selectively combining at least two of the preloaded rotation settings to generate the selected rotation setting.

7. The moving-path editor of claim 1, wherein the combination module has an aggregation module for selectively combining at least two of the preloaded scale settings to generate the selected scale setting.

8. The moving-path editor of claim 1, further comprising an addition/deletion module for adding or deleting the preloaded transition settings of the transition parameter group.

9. The moving-path editor of claim 1, further comprising an addition/deletion module for adding or deleting the preloaded rotation settings of the rotation parameter group.

10. The moving-path editor of claim 1, further comprising an addition/deletion module for adding or deleting the preloaded scale settings of the scale parameter group.

11. A method of editing a moving path of a multimedia object, comprising the following steps:
selecting a transition setting from a plurality of preloaded transition settings pertaining to a transition parameter group;
selecting a rotation setting from a plurality of preloaded rotation settings pertaining to a rotation parameter group;
selecting a scale setting from a plurality of preloaded scale settings pertaining to a scale parameter group;
creating a moving-path setting by combining the selected transition setting, the selected rotation setting and the selected scale setting; and
applying the moving-path setting to the multimedia object for generating the moving path of the multimedia object.

12. The method of claim 11, wherein the step of creating the moving-path setting further includes a step of independently accumulating at least two of the preloaded transition settings pertaining to the transition parameter group to generate the selected transition setting.

13. The method of claim 11, wherein the step of creating the moving-path setting further includes a step of independently accumulating at least two of the preloaded rotation settings pertaining to the rotation parameter group to generate the selected rotation setting.

14. The method of claim 11, wherein the step of creating the moving-path setting further includes a step of independently accumulating at least two of the preloaded scale settings pertaining to the scale parameter group to generate the selected scale setting.

15. The method of claim 11, further comprising a step of adding or deleting the the preloaded transition settings pertaining to the transition parameter group, the preloaded rotation settings pertaining to the rotation parameter group and the preloaded scale settings pertaining to the scale parameter group.

16. The method of claim 13, further comprising a step of previewing the corresponding effect of selecting the preloaded transition settings, the preloaded rotation settings and the preloaded scle settings in a preview area.
